(19) United States
(12) Patent Application Publication
(10) Pub. No.: US 2019/0281805 A1
(43) Pub. Date: Sep. 19, 2019

(54) ADAPTIVE INSECT TRAP

(71) Applicant: Breakthrough Technologies, LLC, Boston, MA (US)

(72) Inventor: Kamal Jaffrey, Winchester, MA (US)

(21) Appl. No.: 16/319,194

(22) PCT Filed: Jul. 21, 2017
(86) PCT No.: PCT/US17/43338

§ 371 Date: Jan. 18, 2019

Related U.S. Application Data
(60) Provisional application No. 62/365,956, filed on Jul. 22, 2016.
(60) Provisional application No. 62/365,948, filed on Jul. 22, 2016.

(51) Int. Cl. A01M 1/20; A01M 1/04; A01M 1/02; A01M 1/10; A01M 29/12; G05B 13/04

(52) U.S. Cl. CPC A01M 1/2033; A01M 1/04; A01M 1/023; A01M 1/226; A01M 29/12; G05B 13/048; A01M 1/106

(57) ABSTRACT

The current subject matter relates to controlling insects and includes a trap that can vary operation based at least on a target insect. For example, different insects are attracted to and/or repelled by different things, such as gases, orders, lights, and sounds. In general, things that attract a given insect are referred to as attractants and things that repel a given insect are referred to as repellents. By varying the operation of the trap, different attractants and repellants can be used to attract and/or repel specific insects. In addition, these attractants and repellants and/or characteristics thereof can these be varied dynamically based on, for example, time of day, proximity of individuals to the trap, proximity of insects to the trap, geographic location, and the like. Related apparatus, system, articles, and techniques are also described.

### RELATED APPLICATIONS

This application claims priority under 35 U.S.C. § 119(e) to U.S. Provisional Application No. 62/365,948 filed Jul. 22, 2016, and to U.S. Provisional Application No. 62/365,956 filed Jul. 22, 2016, the entire contents of each of which is hereby expressly incorporated by reference herein.

### TECHNICAL FIELD

The subject matter described herein relates to an adaptive insect trap that can be operated to control specific insects such as the Zika carrying Aedes aegypti, which is a type of mosquito.

### BACKGROUND

Mosquitoes are small, midge-like flies. Thousands of species feed on the blood of various kinds of hosts, mainly vertebrates, including humans Though the loss of blood is seldom of any importance to the victim, in passing from host to host, some transmit extremely harmful infections such as malaria, yellow fever, Chikungunya, west Nile virus, dengue fever, filariasis, Zika virus and other arboviruses, rendering it one of the deadliest animal families in the world.

Zika virus disease (Zika) is a disease caused by the Zika virus, which is spread to people primarily through the bite of an infected Aedes aegypti species mosquito. The illness is usually mild with symptoms lasting for several days to a week after being bitten by an infected mosquito. However, Zika virus infection during pregnancy can cause a serious birth defect called microcephaly, as well as other severe fetal brain defects.

In May 2015, the Pan American Health Organization (PAHO) issued an alert regarding the first confirmed Zika virus infection in Brazil. On Feb. 1, 2016, the World Health Organization (WHO) declared Zika virus a Public Health Emergency of International Concern (PHEIC). Local transmission has been reported in many other countries and territories. As of 2016, the Center for Disease Control (CDC) estimates the Aedes aegypti range now extends to a majority of the United States, including all or almost all of the south, southwest and north east United States regions. Further, Zika virus will likely continue to spread to new areas.

No vaccine exists to prevent Zika. Thus, the most effective approach to preventing Zika infection is to avoid mosquito bites. However, many attempts at mosquito control have failed, including the elimination of breeding places; exclusion via window screens and mosquito nets; biological control with parasites or predators; introducing large numbers of sterile males; and genetic methods including cytoplasmic incompatibility, chromosomal translocations, sex distortion and gene replacement. Despite these efforts, the Zika virus remains a Public Health Emergency.

In addition, existing mosquito control techniques often have significant collateral damage to the environment because they terminate other insects, such as bees, butterflies, moths, and the like, whose destruction is bad for the environment.

### SUMMARY

The current subject matter relates to controlling insects such as mosquitos. In some implementations, the current subject matter includes technology that is adaptive to specifically target different types of insects. For example, the current subject matter can be configured to specifically target the Zika carrying Aedes aegypti, flies (including sand flies and black flies), locus, and other types of insects including malaria carriers and cholera vectors. In addition, the current subject matter includes technology that can adapt its operation according to external conditions, such as weather, time of day, and the like.

The current subject matter relates to controlling insects and includes a trap that can vary operation based at least on a target insect. For example, different insects are attracted to and/or repelled by different things, such as gases, orders, lights, and sounds. In general, things that attract a given insect are referred to as attractants and things that repel a given insect are referred to as repellents. By varying the operation of the trap, different attractants and repellants can be used to attract and/or repel specific insects. In addition, these attractants and repellants and/or characteristics thereof can be varied dynamically based on, for example, time of day, proximity of individuals to the trap, proximity of insects to the trap, geographic location, and the like.

For example, an attractant can include an infra-red (IR) source. Modulation of the IR source (e.g., a pattern of light emission) can be varied for targeting specific insects. For example, the frequency, amplitude and duty cycle of a driving signal of the IR source can be varied.

In an example implementation, the adaptive trap can be configured to specifically target the Zika carrying Aedes aegypti while repelling favored insects such as moths and bees. By improving control techniques, protection from bites can be greatly improved.

By leveraging understanding regarding how mosquitos are attracted to and choose their targets for biting, they can be guided away from human locations and distracted from biting humans. By reducing the occurrence of mosquitos biting humans, the transmission of diseases, such as the Zika virus, can be reduced and controlled.

In an aspect, an apparatus includes a fan, an attractant source, a repellent source, and a controller operatively coupled to the fan, the attractant source, and the repellent source. The controller is configured to perform operations comprising: receiving data characterizing a proximity of a person or an insect; and changing a mode of operation of the apparatus based on the received data. The changing the mode of operation includes modifying operation of one or more of the fan, the attractant source, and the repellent source.

One or more of the following features can be included in any feasible combination. For example, the apparatus can further include a remote interface configured to communicate wirelessly; and a data acquisition unit. The data characterizing the proximity of the person or the insect can include an instruction received wirelessly from a mobile device or a remote network gateway. The data can be received by the remote interface. The received data can characterize the proximity of the person and the changing the mode of operation can include increasing an output of the repellant source or increasing an output of the attractant source. The received data characterizes the proximity of the insect and the changing of the mode of operation includes increasing an output of the attractant source and operating the fan.

The data characterizing the proximity of the person or the insect can be received from the data acquisition unit. The received data can include one or more sensor measurements. The controller can be configured to perform further operations comprising: determining, from the received data, one or more data features; and detecting, based on the features, a proximity of a person or an insect. The controller can be configured to perform further operations comprising: classifying, based on the features, a type of insect. Changing the mode of operation can be based on the type of insect. The controller can be configured to perform further operations comprising: communication, using the remote interface, with a second insect trap including a second fan, a second attractant source, a second repellent source; and a second controller; and establishing a communication session with the second insect trap. The received data can characterize the proximity of the person or insect to the second insect trap. The changing of the mode of operation can include increasing an output of the attractant source and operating the fan in response to the received data characterizing proximity of the person to the second trap. The changing of the mode of operation can include increasing an output of the repellent source in response to the received data characterizing proximity of the insect to the second trap.

The attractant source can include one or more of: ultraviolet light source, thermal source, infra-red source, acoustic source, carbon dioxide (CO₂) source, L-lactic acid source, acetone source, dichloromethane source, dimethyl disulfide source, and octanol source. The repellent source can include one or more of: N-diethyl-meta-toluamide (DEET), citronella, malathion, and naled. The data acquisition unit can include one or more of: passive IR sensor, video camera, motion sensor, temperature sensor, moisture sensor, carbon dioxide sensor, geolocation positioning system (GPS), wind sensor, anemometer, and photocell. The controller can include a predictive model for operating the fan, the attractant source, and the repellent source. The controller can be configured to perform operations further comprising: receiving a supervisory signal indicating an effectiveness of the predictive model; and updating the predictive model in response to the supervisory signal.

The controller can be configured to perform further operations comprising: recording an output of the data acquisition unit; and transmitting, using the remote interface, the recorded output of the data acquisition unit to the mobile device or the remote network gateway.

In another aspect, a method includes receiving, by a controller, data characterizing a proximity of a person or an insect. The controller is operatively coupled to a fan, an attractant source, and a repellent source. The method includes changing, based on the received data, a mode of operation of one or more of the fan, the attractant source, and the repellent source.

The insect can include a pathogen. The pathogen can include Chikungunya virus; Dengue fever virus (DENY); RVF virus; Yellow fever virus; Zika virus; Plasmodium falciparum; Plasmodium vivax; Plasmodium ovale; Plasmodium malariae; Japanese encephalitis virus; Wuchereria bancrofti; Brugia malayi; Brugia timori; and/or West Nile virus (WNV).

In some implementations, the insect trap can be configured to trap Aedes genus mosquitoes but not Anopheles or Culex. In some implementations, the insect trap can be configured to trap Anopheles but not Aedes or Culex. In some implementations, the insect trap can be configured to trap Culex but not Aedes or Anopheles. In some implementations, the insect trap can be configured to trap Anopheles and Aedes but not Culex. In some implementations, the insect trap can be configured to trap Anopheles and Culex but not Aedes. In some implementations, the insect trap can be configured to trap Aedes and Culex but not Anopheles.

One or more of the following features can be included in any feasible combination. For example, the controller can be further operatively coupled to: a remote interface configured to communicate wirelessly; and a data acquisition unit. The data characterizing the proximity of the person or the insect can include an instruction received wirelessly from a mobile device or a remote network gateway. The data can be received by the remote interface. The received data can characterize the proximity of the person and the changing the mode of operation includes increasing an output of the repellant source or increasing an output of the attractant source. The received data can characterize the proximity of the insect and the changing of the mode of operation can include increasing an output of the attractant source and operating the fan. The data characterizing the proximity of the person of the insect can be received from the data acquisition unit. The received data can include one or more sensor measurements. The method can further include determining, from the received data, one or more data features; and detecting, based on the features, a proximity of a person or an insect. The method can further include classifying, based on the features, a type of insect, wherein changing the mode of operation is based on the type of insect.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram of an example adaptive insect trap;

FIG. 2 is a cross-section of a representation of the trap;

FIG. 3 illustrates a cross-section of an example trap with the air-flow illustrated;

FIGS. 4A and 4B illustrate an example implementation of an adaptive trap with fins;

FIG. 5A is a diagram of an example electrostatic trap; and

FIG. 5B is a perspective view of the electrostatic trap.

FIG. 6 is a process flow diagram of an example method of operating an adaptive insect trap.

FIG. 7 illustrates a user process flow block diagram according to some implementations of the current subject matter.

FIG. 8 illustrates another user process flow block diagram according to some implementations of the current subject matter.

FIG. 9 illustrates an example graphical user interface 900 of a mobile device according to some implementations of the current subject matter.

FIG. 10 illustrates an example insect control suction system;

FIG. 11 is a front view of an example air suction system for use with a stadium or other large gathering space;

FIG. 12 is a cross-sectional view of an example air suction system for use with a stadium or other large gathering space;

FIG. 13 is a cross-sectional diagram of an example duct illustrating how duct can be sized to accommodate between 60 cfm and 100 cfm of airflow for a large number of ports;

FIG. 14A is a top view and FIG. 14B is a side perspective view of an example high-contrast attractant panel.

FIG. 15 is a diagram illustrating an insect trap incorporating a high-contrast attractant surface, which can be combined with other attractants or repellants, for example, in liquid form;

FIG. 16 is an illustration of a fanless trap utilizing a high-contrast visual attractant surface;

FIG. 17 is a diagram illustrating regions of influencing Aedes aegypti for protecting an area;

FIG. 18 is a diagram illustrating how multiple systems can be used to protect a large geographic region; and

FIG. 19A is a side view and FIG. 19B is a top view of an example high-contrast attractant panel suction trap having multiple sucking regions.

Like reference symbols in the various drawings indicate like elements.

### DETAILED DESCRIPTION

The current subject matter relates to controlling insects and includes a trap that can vary operation based on a target insect, a proximity or identification of the insect, a proximity of a person, and the like. For example, different insects are attracted to and/or repelled by different things, such as gases, orders, lights, and sounds. In general, things that attract a given insect are referred to as attractants and things that repel a given insect are referred to as repellents. By varying the operation of the trap, different attractants and repellants can be used to attract and/or repel specific insects. In addition, these attractants and repellants and/or characteristics thereof can be varied dynamically based on, for example, time of day, proximity of individuals to the trap, proximity of insects to the trap, membership in a network of insect traps, geographic location, and the like.

Mosquitos, in general, are attracted to certain characteristics, such a carbon dioxide and large infra-red (IR) sources. Mosquitos are also, in general, repelled by certain things, such as the compound DEET (N-diethyl-meta-toluamide). However, different mosquito species are attracted to and repelled by different things. Described herein is a trap that can control and/or configure to present attractants based on a target insect, such as the Aedes aegypti mosquito. The following table provides example mosquito genus, associated pathogens, and resultant diseases.

| Genus | Pathogen | Resulting Disease |
|---|---|---|
| Aedes | Chikungunya virus | Chikungunya |
| | (CHIKV), an RNA virus and | |
| | a member of the alphavirus | |
| | genus, and Togaviridae family. | |
| | Dengue fever virus | Dengue fever |
| | (DENV), an RNA virus of | |
| | the family Flaviviridae; | |
| | genus Flavivirus | |
| | RVF virus (RVFV) a | Rift Valley fever |
| | member of the genus | |
| | Phlebovirus in the family | |
| | Bunyaviridae | |
| | Yellow fever virus, an | Yellow fever |
| | RNA virus of the genus | |
| | Flavivirus | |
| | Zika virus, a member of | Zika |
| | the Flaviviridae family | |
| Anopheles | protozoan parasites of the genus | Malaria |
| | Plasmodium including | |
| | Plasmodium falciparum and | |
| | Plasmodium vivax, Plasmodium | |
| | ovale and Plasmodium malariae, | |
| | among others. | |
| Culex | Japanese encephalitis | Japanese |
| | virus, an RNA virus of the | encephalitis |
| | genus Flavivirus | |
| | Worms Wuchereria | Lymphatic |
| | bancrofti, Brugia malayi, and | filariasis |
| | Brugia timori. | |
| | West Nile virus (WNV) a RNA | West Nile fever |
| | virus of the Flaviviridae family. | |

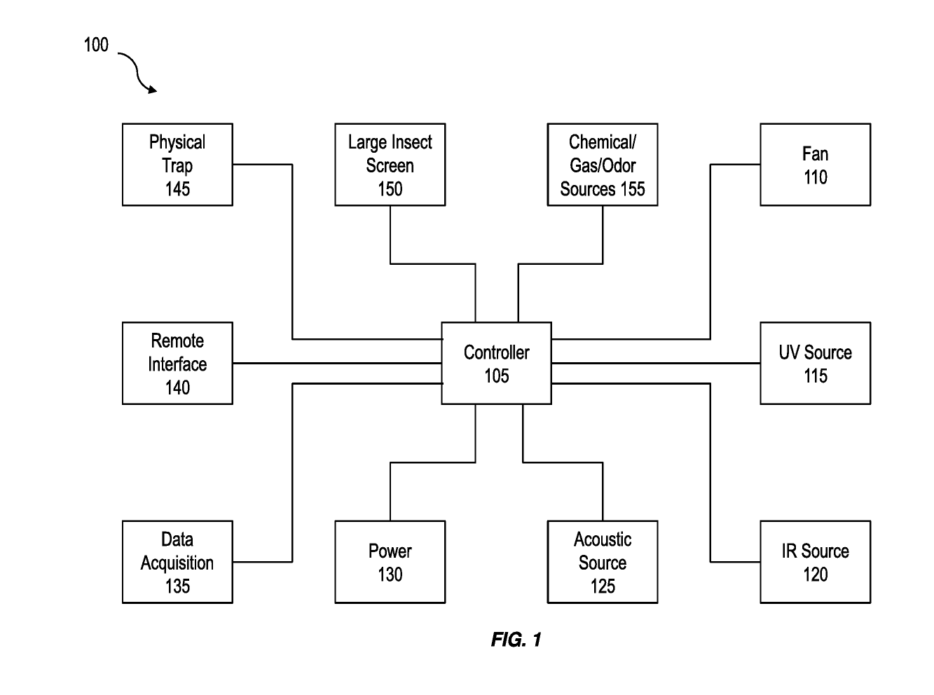

FIG. 1 is a system block diagram of an example adaptive insect trap 100. The trap 100 includes a controller 105 in operative communication with a number of modules. The modules include a fan 110, ultra violet (UV) source 115, IR source 120, acoustic source 125, power source 130, data acquisition unit 135, remote interface 140, a physical trap 145 (e.g., insect control module), a large insect screen 150, and chemical sources 155. Each module can include its own power unit and/or control unit.

The fan 110 can include an apparatus with rotating blades that creates a current of air for sucking nearby insects into the physical trap 145, which can include a bag or container for trapping insects. The fan 110 can also take the form of an indirect suction means (e.g., bladeless suction), such as a device utilizing the Venturi effect. In some implementations, the physical trap 145 can include an open vessel containing a liquid such as water. In some implementations, the physical trap 145 includes a condenser, which may be passive or active, for sourcing the water from the environment (e.g., by capturing dew). The condenser reduces or eliminates the requirements for continued maintenance to supply the trap 100 with water.

UV source 115 can include a UV lamp or light emitting diode (LED) and can be within a given UV band. For example, the UV source can emit one or more of UV-A, UV-B, and UV-C. The UV source 115 can include a UV-A source, a UV-B source, and a UV-C source, each being selectively controlled by controller 105 to emit at their respective frequencies.

IR source 120 can include an IR lamp or LED and can be able to emit light within a given IR band. For example, the IR source 120 can emit one or more of near IR (e.g., having a wavelength of 0.76 to 1.5 microns), middle IR (e.g., having a wavelength of 1.5 to 5.6 microns), or far IR (e.g., having a wavelength between 5.6 and 1000 microns). The IR source 120 can include a near IR source, a middle IR source, and a far IR source, each being selectively controlled by controller 105 to emit at their respective frequencies.

The UV source 115 and IR source 120 can include light sources such as lamps or LEDs that serve as heat sources, which can act as attractants for the insect. In some implementations, a separate heat source can be included in the trap 100.

Acoustic source 125 can include a speaker that can emit sound at varying frequency such as a piezo-electric device or transducer. For example, the acoustic source 125 can emit sound between 20 and 20,000 Hz, which are audible frequencies. In an example implementation, the acoustic source 125 can emit sound at 484 Hz, which is the frequency that female Aedes aegypti flap their wings, thereby serving as an attractant to male Aedes aegypti. In addition, acoustic source 125 can include an acoustic transducer to serve as a control means. An acoustic transducer can emit focused acoustic sound that serves to injure an insect, for example, by piercing their wings, and control (e.g., kill) the insect. In an example implementation, the acoustic transducer can emit sound at and around 25,000 Hz frequency. In some implementations, the acoustic transducer can produce sound below 20 HZ or above 20,000 Hz.

Power source 130 can include one or more of batteries, power cord, solar power, thermal electric generator, and the like. In some implementations, an external concentrated light beam can be used to power the trap 100 remotely by directing the concentrated light beam onto a solar cell of the trap 100.

Data acquisition unit 135 can include sensors. The sensors can include visual sensors such as a passive IR sensor, video camera, motion sensor, and the like, as well as other sensors such as temperature sensor, moisture sensor, carbon dioxide sensor, geolocation positioning system (GPS), wind sensor (e.g., anemometer), photocell (e.g., LDR); and the like. Multiple sensors and/or viewing angles can be used to view and classify nearby insects. For example, multiple video cameras can be used or mirrors, prisms, class, beam splitters and the like can be used to create multiple viewing angles. Information acquired from one or more sensors and one or more viewing angles can undergo sensor fusion.

Remote interface 140 can include a communications module for communicating with external devices and data sources. In some implementations, the remote interface 140 includes a wireless radio (e.g., blue tooth, WIFI, cellular and the like) and can retrieve information such as weather, software updates, public health department distributed information (e.g., relating to control and monitoring of insects), and the like from a remote source.

The remote interface 140 can also interface with a remote control unit, such as a mobile device or other networked device. The remote interface 140 can receive instructions from the remote control unit, such as instructions to reconfigure to target a different insect, to change operating parameters such as types and strengths of attractants and repellents, proximity of the remote control unit, and the like.

The remote interface 140 can also interface with other traps 100, for example, to establish an ad-hoc network of insect traps. Multiple traps 100 can operate together to provide greater protection, for example, one trap 100 can operate in a repellant mode while another trap 100 can operate in an attractant mode to direct the target insects away from a building, for example.

A large insect screen 150 can be included, for example, to protect insects that are not the target insect from the trap 100. For example, bees are beneficial to the environment. The large insect screen 150 can be sized to allow smaller insects, such as mosquitos, through the screen, while preventing larger insects, such as bees, from being terminated by the trap 100.

Chemical sources 155 can include one or more chemical, gas, or odor sources that can serve as an attractant or repellent. For example, the following are chemical, gas, and odor attractants for Aedes aegypti: CO₂, L-lactic acid, acetone, dichloromethane, dimethyl disulfide, octanol, and the like. The following are example chemical, gas, and odor repellents for Aedes aegypti: DEET, citronella (an oil distilled from two naturally occurring grass varieties), malathion (an organophosphate insecticide typically applied as an ultra-low volume spray that kills mosquitos on contact) and naled (an orgranophosphate insecticide typically applied to agricultural crops as an ultra-low volume spray that kills mosquitos on contact). In some implementations, the repellent used can be environmentally friendly (e.g., Environmental Protection Agency approved).

Chemical sources 155 can include cartridges of the appropriate chemicals, gases, or odors. Additionally, the source can include combustion or chemical reactions that produce the desired source. In some implementations, the speed or strength of chemical release can be controlled by controller 105.

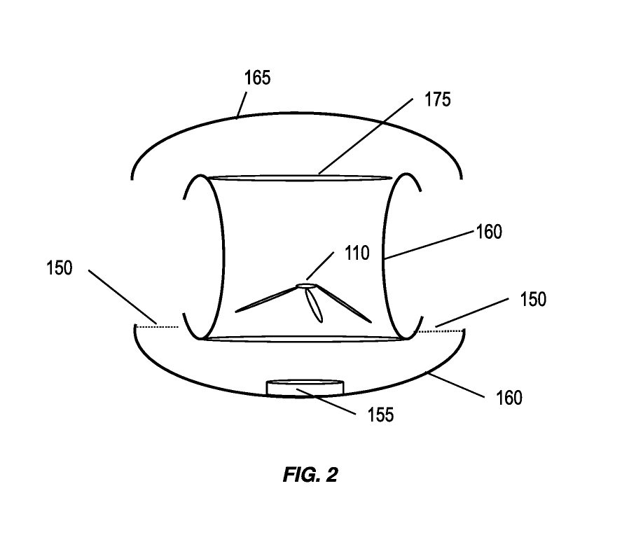

FIG. 2 is a cross-section of a representation of the trap 100. The trap 100 is modular and includes a center housing 160 that includes features for adding or removing modules based on an intended implementation. Thus, the trap 100 can be configured with greater or fewer components depending on desired costs, location of use, potential target insects, and the like. The components can include the modules described above with respect to FIG. 1. Thus, the trap 100 can include “plug and play” components.

The housing 160 can include a cap 165 and base 170. The housing 160 can be hollow and contain fan 110. Fan 110 can be configured such that, when operated, fan 110 causes air to flow through the hollow housing 160 from the base 170 to the cap 165. The housing 160 can include lip-like features at the entrance and exit of the housing 160 to improve air flow. In addition, a barrier 175, such as a screen or gate, can be included to trap any insects that are sucked into the trap housing 160.

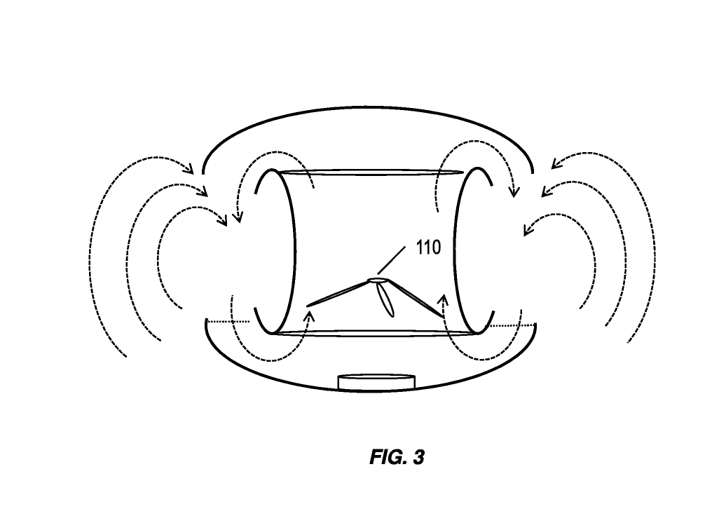

In operation, the housing 160 is shaped so that fan 110 can serve to recycle the chemical and odor attractants and repellents by creating a circular air flow. The circular flow is created by the curved interior of the cap 165, curved interior of the base 170, and lips on housing 160. For example, FIG. 3 illustrates a cross-section of an example trap 100 with the air-flow illustrated. The fan 110 creates a suction field so that any carbon dioxide and other attractants and repellents flow in a circular manner, limiting their disbursement. This enables the trap to operate with less chemical, gas, and odor attractant and/or repellant, and/or for longer periods of time using the same amount of chemical, gas, and/or odor attractant and repellant. Further, the circular air flow enables longer lasting control (e.g., temporal control), higher efficacy (e.g., more steady chemical, gas, and/or odor presence); improved energy efficiency (e.g., lower fan energy consumption); and enables timed control optimization (e.g., the turning of the fan on and off at appropriate times and recycling ambient and background carbon dioxide).

In addition, when the fan 110 operates, any insects within a distance (which can vary based on the strength of the fan, which can be varied during operation) is over-powered by the suction field and sucked into the trap 110. The intake zone is relatively small because air velocity is highest at the entrance to the trap but air velocity reduces quickly as distance from the trap increases. In addition, the intake zone of the trap depends on the insect to be controlled. For example, the flying speed of an Aedes aegypti mosquito is between 1.5 and 0.5 mph, thus the effective intake zone of the trap is limited to a relatively small area in which the airspeed is greater than 0.5 mph. However, a small intake zone is not a weakness if it is used in conjunction with an effective attractant that can draw the insect to a very specific location. Thus, in some implementations, the attractants used can combine chemicals, gas, and/or odors with additional attractants, such as visual (e.g., high-contrast patterns, UV), and thermal attractants (e.g., IR source) to attract the insects to the intake zone.

In addition, fan 110 can be operated intermittently. For example, fan 110 can cycle between being on for 20 seconds and off for 2 minutes. This has been shown to improve insect trapping while reducing power consumption.

In operation, the data acquisition unit 135 acquires sensor data such as environmental data (e.g., temperature, moisture, weather, carbon dioxide concentrations, and the like), and image data (e.g., from a passive IR sensor, video camera, motion sensor, and the like) and provides the data to the controller 105. Based on the image data, the controller 105 can determine a mode of operation. The mode of operation can include parameters for operating one or more of the fan 110, UV source 115, IR source 120, and acoustic source 125. For example, the controller can determine if the target insect is present. For example, computing one or more features of the sensor data, detecting an insect, and classifying the insect type using the determined features. If target insect is determined to be present, the fan 110, IR Source 120, and UV source 115 can be operated. The IR source 120 serves to attract the target insect closer and to distract the target insect from any nearby person that could be a potential host, while the UV source 115 blinds the insect and the fan 110 causes the insect to be trapped once it enters to intake zone.

In some implementations, the controller 105 can determine a mode of operation of the trap 100 as being either a control device (e.g., to control insects) or a surveillance device (e.g., to report and/or its sensor data).

The controller 105 can determine a mode of operation based on the environmental data. For example, if it is determined that it is raining, the controller 105 may turn off some of the modules to save power because it is unlikely that insects will be nearby during a rain storm. Similarly, the controller 105 can determine a mode of operation based on the time of day, for example, some insects are more active during the day and less active at night. The controller 105 can operate modules accordingly to save energy.

In addition, controller 105 can determine that a person is proximate and determine a mode of operation based on a person being proximate. For example, when a person gets close to a trap 100, the trap 100 can increase the output of attractants to increase the likelihood that any nearby target insects will be attracted to the trap 100, and not the person. Thus, the trap 100 can serve to “cloak” nearby people from the target insects. In some implementations, an indication that a person is proximate can be received by the remote interface 140 from a mobile device.

In addition, the remote interface 140 can receive instructions from a remote device. The instructions can include, for example, instructions to reconfigure the trap 100 to operate as an attracting trap or a repelling trap. The instruction can be received, for example, from another trap having identified the presence and/or proximity of an insect and/or a person. The two traps can be members in a network, such as an ad-hoc network, of traps that communicate and coordinate in order to intelligently provide insect control. The remote interface 140 can provide the instruction to controller 105. The controller 105 can modify operation so the fan 110, UV source 115, IR source 120, acoustic source 125, and/or chemical sources 155 operate differently based on received instruction.

The instructions can include, for example, instructions to reconfigure the trap 100 for a different target insect. For example, the trap 100 can be configured to attract and control black flies. The remote interface 140 can receive an instruction from a remote device to instead trap Aedes aegypti mosquitos. The remote interface 140 can provide the instruction to controller 105. In an implementation, controller 105 includes a table of potential target insects and corresponding module operating parameters. The controller 105 can modify operation so the fan 110, UV source 115, IR source 120, acoustic source 125, and chemical sources 155 operate differently based on the target insect.

The trap 100 can reconfigure for a different target insect based on additional factors. For example, time of day and weather conditions.

In some implementations, the trap 100 can include a predictive model (e.g., on controller 105) that can be trained to target specific insects. For example, a first operating mode specifying operational parameters of one or more components of the trap can be received by the trap 100 (e.g., remote interface 140), for example, from a remote device. The trap 100 can then operate according to that first operating mode for a time period (e.g., 1-hour). The trap 100 can then receive one or more supervisory signals, which can include an indication that the mode of operation was effective or not effective at controlling a particular insect. The supervisory signal may originate, for example, from a user evaluating the trap's effectiveness on a mobile device. The trap 100 can then adjust (e.g., randomly, using a heuristic, and/or using another algorithm) the operational parameters. The training can repeat until the trap 100 is considered to be effective in targeting a particular insect. Such an approach allows the adaptive trap 100 to be used in many different environments and to target many different insects. Moreover, the adaptive trap 100 need not be preconfigured for a particular environment or insect.

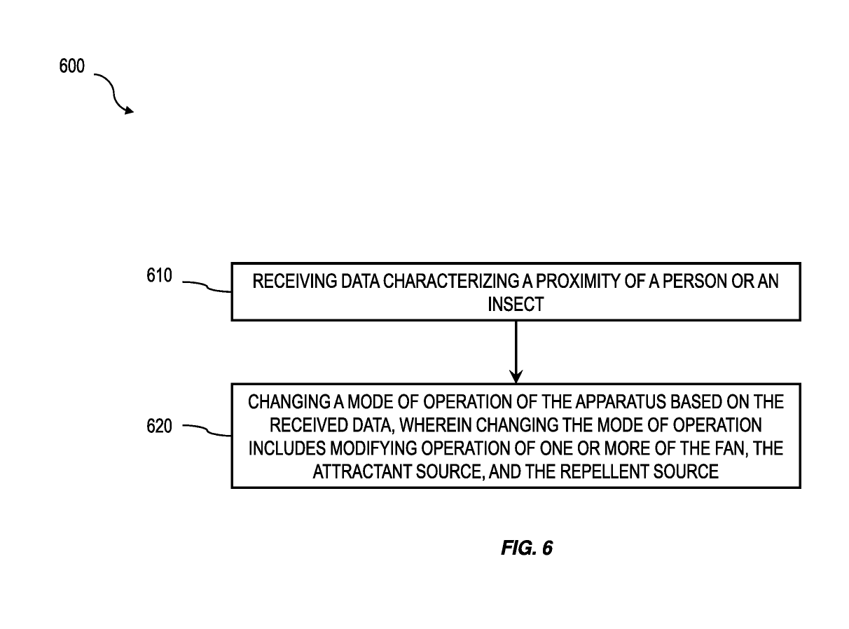

FIG. 6 is a process flow diagram 600 illustrating a process of adapting an insect trap. At 610, data is received characterizing a proximity of a person or an insect. At 620, a mode of operation of the insect trap can be modified based on the received data. Changing the mode of operation can include modifying operation of one or more of the fan, the attractant source, and the repellent source.

The data characterizing the proximity of the person or the insect can include an instruction received wirelessly from a mobile device or a remote network gateway. When the received data characterizes the proximity of the person, the changing the mode of operation can include increasing an output of the repellant source or increasing an output of the attractant source. When the received data characterizes the proximity of the insect, the changing of the mode of operation can include increasing an output of the attractant source and operating the fan.

The data characterizing the proximity of the person of the insect can be received from the data acquisition unit. The received data can include one or more sensor measurements.

In some implementations, one or more data features can be determined from the received data. For example, if the received data is audio data, a frequency of the audio data can be determined. In some implementations, a proximity of a person or an insect can be detected based on the features. In some implementations, a type of insect can be classified. Then, changing the mode of operation can be based on the type of insect.

The insect trap can communicate, using the remote interface, with a second insect trap. A communication session can be established with the second insect trap to form a network. Multiple insect traps can form a communication session to form an ad-hoc network. When the received data characterizes the proximity of the person or insect to the second insect trap, the changing of the mode of operation can include increasing an output of the attractant source and operating the fan in response to the received data characterizing proximity of the person to the second trap. The changing of the mode of operation can include increasing an output of the repellent source in response to the received data characterizing proximity of the insect to the second trap.

In some implementations, the controller includes a predictive model for operating the fan, the attractant source, and the repellent source. The predictive model can provide as output the operational parameters of one or more components of the insect trap. The controller can receive a supervisory signal indicating an effectiveness of the predictive model and update the predictive model in response to the supervisory signal.

In some implementation, the insect trap can act as an environmental sensing unit in addition to an insect trap. For example, the insect trap can record an output of the data acquisition unit and transmit, using the remote interface, the recorded output of the data acquisition unit to the mobile device or the remote network gateway.

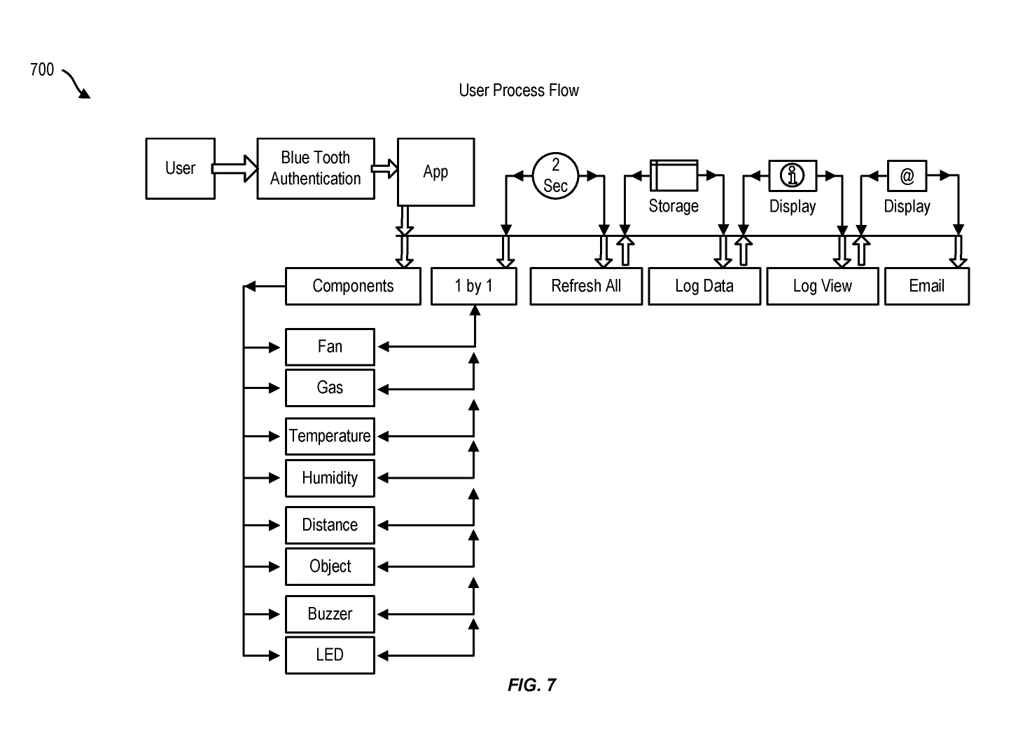

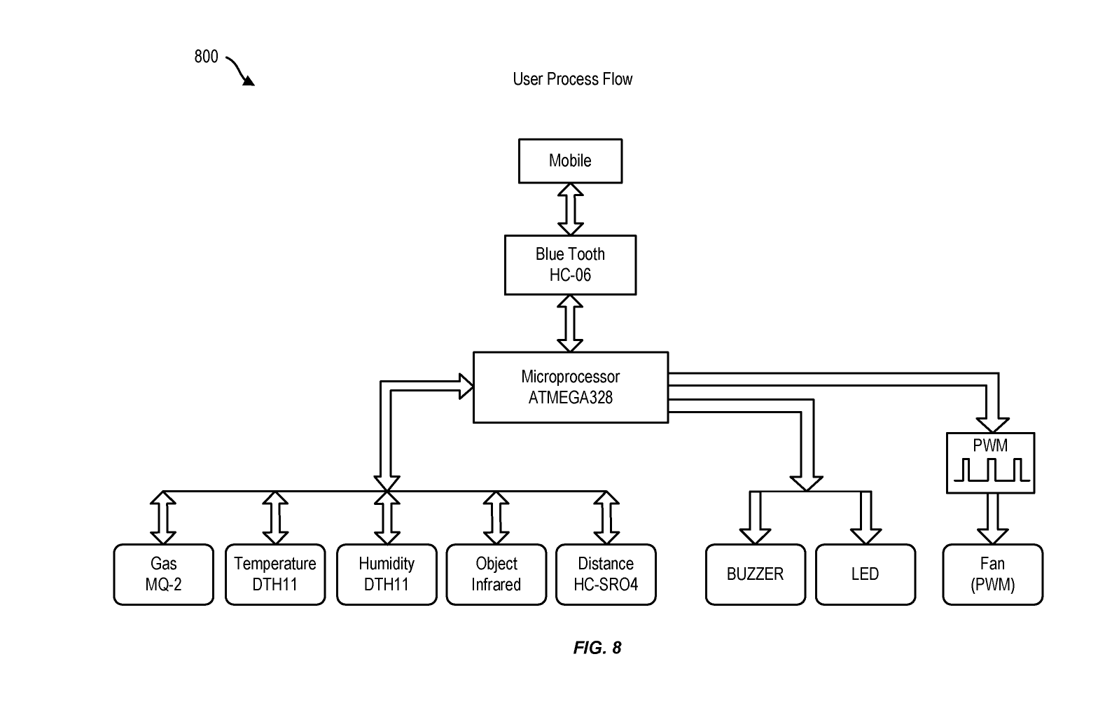

FIG. 7 illustrates a user process flow block diagram 700 according to some implementations of the current subject matter. FIG. 8 illustrates another user process flow block diagram 800 according to some implementations of the current subject matter.

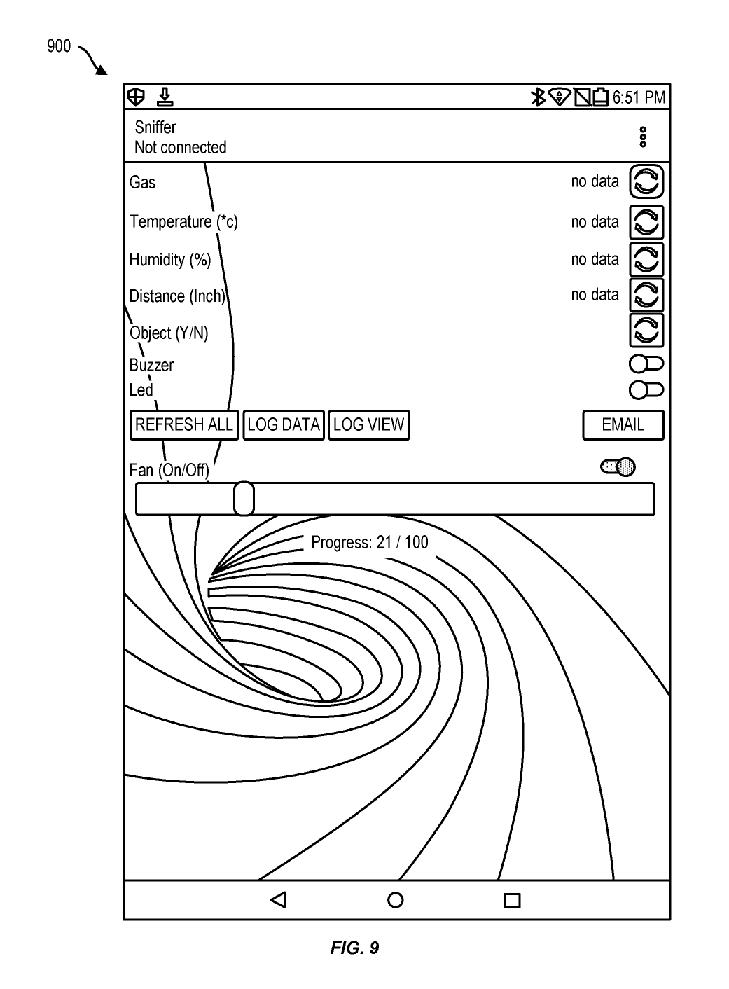

FIG. 9 illustrates an example graphical user interface 900 of a mobile device according to some implementations of the current subject matter. The user interface enables a user to interact remotely with the adaptive insect trap. The user can open an application using a mobile device, connect to trap with a wireless communication (e.g., bluetooth), activate or start device fan for data acquisition, click individual (component) button for data acquisition, for data stream click on refresh all button: this will display data with the interval of 2 seconds, select log data button to save all data on mobile storage, select view data to show all saved information on screen, and select email to send all data as a text file format to a user's email address.

Aedes aegypti

Mosquitos, in general, are attracted to certain characteristics, such a carbon dioxide and large infra-red (IR) sources. Mosquitos are also, in general, repelled by certain things, such as the compound DEET (N-diethyl-meta-toluamide). However, different mosquito species are attracted to and repelled by different things. Thus, to target control of the Zika carrying Aedes aegypti, the appropriate attractants and repellants (or suppression thereof) should be used.

The Zika carrying Aedes aegypti, also known as the yellow fever mosquito, is a mosquito that can be recognized by white markings on its legs and a marking shaped as a lyre on the upper surface of the thorax. The Aedes aegypti originated in Africa but is now found in tropical and subtropical regions throughout the world. The Aeges aegypti is between 1.67 and 3.83 millimeters in width, about 6 millimeters in length and about 2 5 milligrams mass on average, although some can grow as large as 10 milligrams. The Aeges aegypti can fly to about 25 feet in altitude and can fly about 0.5-1.5 miles per hour (mph). Over the course of an Aedes aegypti lifespan, the Aedes aegypti will fly at most range over several hundred meters.

The Aedes aegypti is a vector for transmitting several diseases. Only the females bite for blood to mature her eggs. To find a host, these mosquitos are attracted to compounds emitted by mammals including ammonia, carbon dioxide, lactic acid, and octanol. The Aedes aegypti most commonly feed at dusk and dawn, indoors, and in shady areas, but they can bite and spread infection at any time of day or year. The Aedes aegypti prefer to breed in areas of stagnant water.

The lifespan of an adult Aedes aegypti is two to four weeks, although their eggs can be viable for years, which allows the mosquitos to reemerge after a cold winter or dry spell. Adult female Aedes aegypti lay eggs in containers that hold water. The eggs hatch within a few days to months when covered with water. The larva that emerge live in water and develop into pupae in as few as 5 days. The pupae live in water and develop into adult, flying mosquitos in 2-3 days.

The Aedes aegypti use a complicated series of senses to choose a host for feeding, including visual, olfactory, and thermal cues. van Breugel, Floris and Riffell, Jeff and Fairhall, Adrienne and Dickinson, Michael H. (2015) Mosquitoes Use Vision to Associate Odor Plumes with Thermal Targets. Current Biology, 25 (16). pp. 2123-2129. ISSN 0960-9822. PMCID PMC4546539. In particular, mosquitos use vision to associate odor plumes with thermal targets. Initially, from about 10 to 50 meters away, an Aedes aegypti smells a host's CO₂ plume. It then follows the CO₂ trail and flies closer to the CO₂ source. When within 5 to 15 meters, it begins to see the host (visually). In particular, Aedes aegypti are visually attracted to high-contrast low-reflectivity darker objects. Then, guided by visual cues that draw it even closer, to within 20 centimeters, the Aedes aegypti can sense the host's body heat.

Other olfactory cues in addition to CO₂ can include L-lactic acid, acetone, dichloromethane, dimethyl disulfide, and octanol. Other visual cues can include light (e.g., IR and ultraviolet (UV)). The visual cues, including high-contrast surfaces, do not attract the Aedes aegypti without the presence of CO₂ or other olfactory cues. In other words, a mosquito will not see a host until they smell the host. The Aedes aegypti also shows a preference for warmer objects (although this preference is not dependent on the presence of CO₂), standing water, humid weather conditions with low wind velocity, daylight, materials with high carbon content (for example, tires), and odors and gases emitted from rotting foods and animal wastes. Male Aedes aegypti in particular are attracted to sound having a 484 Hz frequency, which is the rate at which female Aedes aegypti flap their wings.

When presented with multiple attractant sources, the Aedes aegypti will typically go toward the larger attractant source. For example, if presented with two different CO₂ trails, the Aedes aegypti will typically follow the larger CO₂ trail.

Thus, the attractants for Aedes aegypti can be summarized as at least CO₂, L-lactic acid, acetone, dichloromethane, dimethyl disulfide, octanol, IR sources, UV sources, thermal sources, standing water, humidity, low wind velocity, daylight, materials with high carbon content (for example, tires), and odors and gases emitted from rotting foods and animal wastes.

Repellants generally include chemicals and pesticides that are toxic or otherwise repel the Aedes aegypti. For example, chemical repellents can include DEET, citronella (an oil distilled from two naturally occurring grass varieties), malathion (an organophosphate insecticide typically applied as an ultra-low volume spray that kills mosquitos on contact) and naled (an orgranophosphate insecticide typically applied to agricultural crops as an ultra-low volume spray that kills mosquitos on contact).

The current subject matter can include trap that creates localized pressure differential

The following illustrates example calculations for determining trap 100 properties for an example trap 100 having 500 CFM and 5 ports.

$$Q = 500 CFM Where Q is the total volume flow ( 100 cfm * \# ports )$$

$$Duct Velocity Pressure ( VP ) = {( \frac{V}{4005} )}^{2}$$

$$V = f ( suction pickup )$$

$$suction pickup = 2.0 ( inches water column ( inWC ) \\ V = 3500 ( feet per minute ( fpm ) ) \\ Duct Area = A = \frac{CFM}{V} \\ Duct Diameter = D = 13.54 \sqrt{A} \\ Ratio = \frac{Duct Length}{Duct Diameter} = \frac{L}{D} = \frac{12 L}{D} \\ Duct Friction Loss = F = 0.0195 * ( \frac{12 L}{D} ) * VP$$

In some implementations, the trap 100 can also include a CO₂ removal component to remove CO₂ from the air that is drawn into the device. In particular, by removing or reducing the CO₂ surrounding a person, Aedes Aegypti are less likely to become activated and search for a host. The CO₂ removal component can include passing the air that is sucked into the trap through a cartridge containing a CO₂ removal compound, which can include, for example, soda lime, calcium hydroxide, and sodium hydroxide. This may be desirable, for example, when multiple traps are used in combination. The traps can form a network (e.g., an ad-hoc network), and coordinate to create regions of high attractants, high repellants, and/or low attractants. These regions can be located to direct any insects away from populated areas (e.g., a building, porch, backyard, and the like). By reducing Aedes aegypti attractants, the trap 100 can serve to cut the trail the Aedes aegypti follow to find a host.

Soda lime is a mixture of chemicals that is created by treating Calcium hydroxide with concentrated sodium hydroxide solution. The main components of soda lime are calcium hydroxide Ca(OH)₂, water H₂0, sodium hydroxide, NaOH and Potassium hydroxide KOH. Calcium hydroxide is a colorless crystal or white powder and is obtained when calcium oxide is mixed with water. Sodium hydroxide NaOH is also known as lye or caustic soda.

High-Contrast Attractant Surfaces and Traps

The current subject matter can include a high-contrast mosquito attractant surface. In some implementations, the trap can include panels or fins with a high-contrast surface. Because Aedes aegypti are attracted to high-contrast objects, they will be further attracted to the trap and not any nearby humans.

Aedes aegypti host seeking strategy includes visually seeking out a host within 5 to 15 meters. The Aedes aegypti will choose the best visual target within its field of view. For example, if a human is standing next to a cow, the Aedes aegypti will more likely choose to land on the cow than the human because the cow is larger.

The Aedes aegypti are visually attracted to objects with high-contrast low-reflectivity and dark surfaces. Thus, the trap 100 can include high surfaces so that, when an Aedes aegypti is visually searching for a host, the Aedes aegypti decides to land on the trap and not a nearby human. The trap can be colored with a black and white high-contrast low-reflectivity (e.g., matte) surface. The pattern can be, for example, a “zebra”-like pattern.

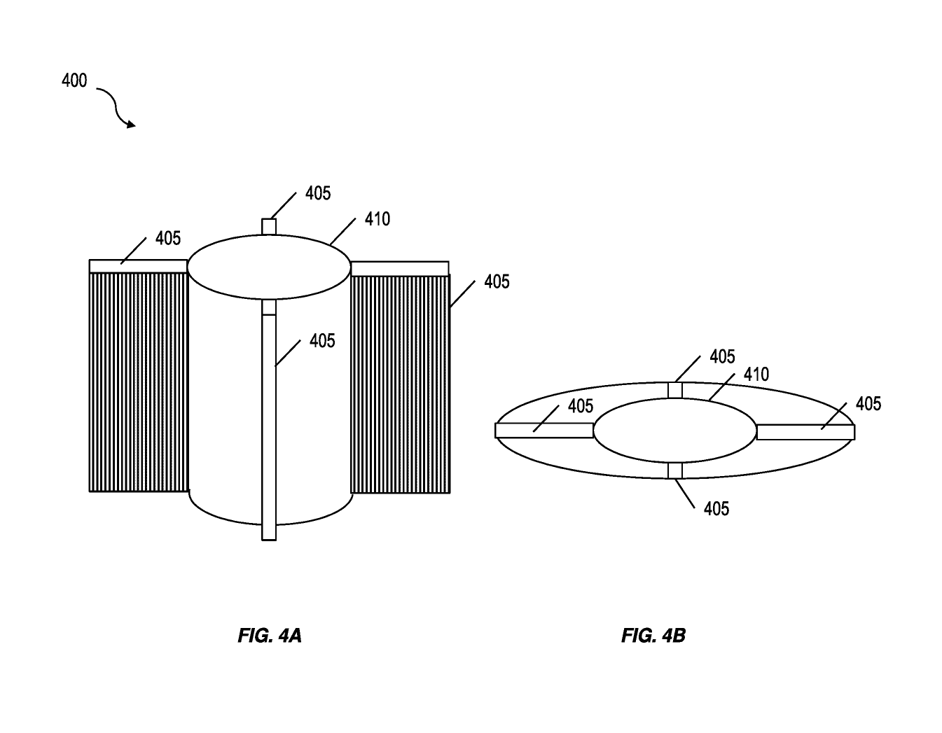

FIGS. 4A and 4B illustrate an example implementation of an adaptive trap with fins 400. FIG. 4A illustrates a perspective view. FIG. 4B is a cross section of the trap 400. The trap 400 includes four fins 405 having a high-contrast surface for attracting certain insects and a center housing 410 having a fan, as described above with respect to FIG. 1. The high-contrast attractant fins can include an alternating dark and light stripped pattern. The pattern can include alternating vertical black and white bars although other patterns (e.g., similar to a zebra) and variations in dark and light color are contemplated. In some implementations, the number of dark bars is greater than the number of light bars.

Although the fins 405 are illustrated as being flat panels (e.g., vertical planes), the fins 405 can take other shapes. For example, the fins 405 can be helical around the center of the trap to improve air flow characteristics and energy efficiency (e.g., by creating a spiral air flow).

Electrostatic Trap

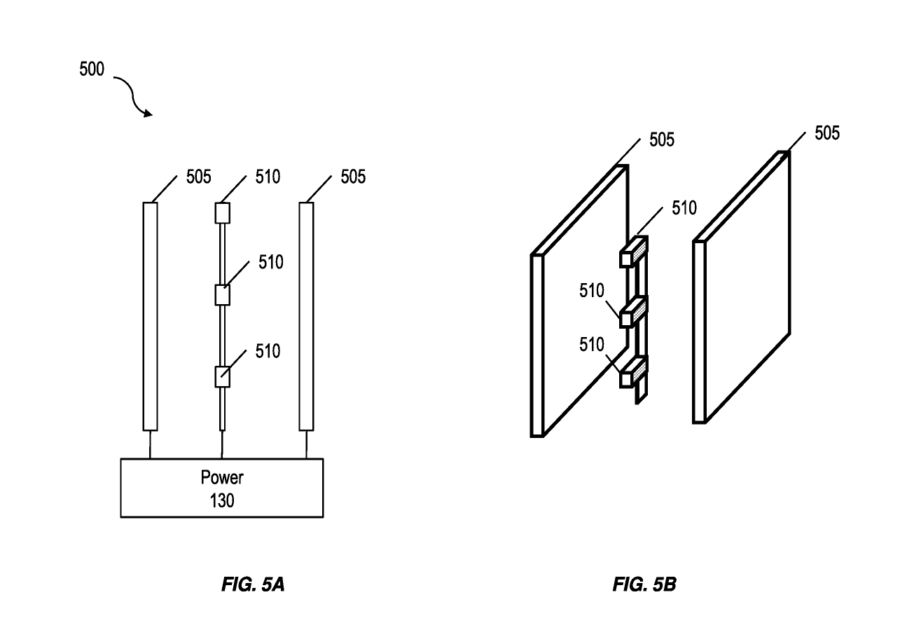

FIG. 5A is a diagram of an example electrostatic trap 500. FIG. 5B is a perspective view of the electrostatic trap 500. The electrostatic trap 500 includes two positively charged plates 505 and one or more electron emitters 510 spaced between the plates 505. The electrostatic trap 500 can include a power source 515.

An insect flying between the charged plates 505 will receive emitted electrons form the electron emitters 510 and become negatively charged. Because a strong electric field exists between (and around) the charged plates 505, the negatively charged insect is attracted to and trapped against one of the charged plates 510.

The force imparted on the insect is characterized by:

$$F = {k}_{e} \frac{\vert {q}_{1} {q}_{2} \vert}{{r}^{2}}$$

$${k}_{e} = 8.99 \times {10}^{9} {Nm}^{2} / {c}^{2}$$

$$r = distance between charges ( m )$$

$${q}_{i} = charge ( c )$$

The electrostatic trap 500 operates under a different principle of operation from traditional “zapper” traps, in which an insect completes a circuit between closely spaced conductive wires, causing a high voltage arc to form. The arc instantly electrocutes the insect and may forcefully disperse potentially allergenic and pathogenic droplets from the exploding insect. The conductive wires forming the grid, however, are generally spaced too far apart to affect some smaller insects. The electrostatic trap 500, in contrast, generally trap and retain insects (causing their death) rather than electrocute and explode the insect.

The electrostatic trap 500 is an electrostatic precipitation (ESP) device. ESP devices are commonly installed in workplaces and homes as HVAC filters, in power plants to limit emission of fly ash, on photocopy machines to retain pigment dusts, and as air cleaners.

In some implementations, the electrostatic trap 500 includes non-conductive plastic including polyethylene-terephthalate (PET) and polymethyl methacrylate (PMMA), which can become charged via friction. Electrostatically charged synthetic fabrics can also serve as charged materials.

Scalable Systems

The current subject matter can relate to controlling mosquitos and can specifically target the Zika carrying Aedes aegypti. The current subject matter can include scalable systems that control air flow providing for protection systems that range in scale from individual and wearable protection systems to systems integrated into locations of large public gatherings, like a stadium. In addition, the current subject matter enables control of mosquitos over larger geographic regions. This can be applied, for example, to control mosquitos at locations of large public gatherings, like a stadium, or throughout an urban area, which may have a large human population. In addition, the current subject matter utilizes and combines multiple approaches at the personal level, local level, and regional level. By layering control techniques, protection from bites can be greatly improved.

Described herein are multiple approaches to controlling insects such as mosquitos and, in particular, approaches that specifically target the Zika carrying Aedes aegypti. The current subject matter includes scalable air suction systems for applications such as wearable technology to deter and/or trap mosquitos attempting to land on exposed skin to air suction systems for places such as stadiums. Also described are personal technology that traps mosquitos that do land on a human, high-contrast mosquito attractant surfaces and traps, and techniques for arranging different insect control technologies and devices over a larger geographic region, such as a city block or an entire city or urban region. Each approach is discussed below in more detail.

Insect Control Suction System

The current subject matter can include an air suction system that creates localized pressure differential near locations that humans are located to create an air flow sufficient to reduce or remove the carbon dioxide and other attractants produced by any nearby humans to limit mosquito attractants. In addition the air flow can be sufficient to trap nearby mosquitos. The localized pressure differential may be created by a system of fans and ducts with aspiration ports. The air suction system can be scaled for many different applications from an individual wearable device to a large stadium, such as a sports stadium or outside amphitheater, to provide protection for the audience during an event.

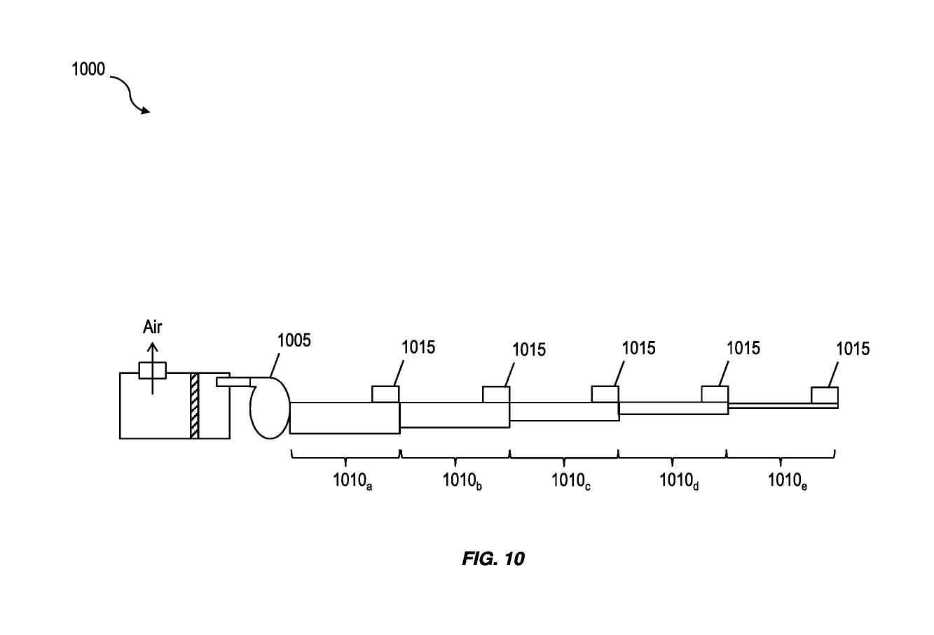

FIG. 10 illustrates an example insect control suction system 1000. The system 1000 provides ports to: 1) trap Aedes aegypti landing on exposed skin by creating a positive suction and air flow; and 2) removes the attractants CO₂ and olfactory attractants like lactic acid from a given area. The air suction system 1000 includes a fan 1005, duct 1010 with aspiration ports 1015 (e.g., vents, apertures, or openings), and mesh trap 1020 at the fan exhaust to trap insects.

Each aspirating port can include an attractant high-contrast surface surrounding the port 1010. For each aspirating port 1015, the air suction system 1000 is able to remove at least 100 cubic feet per minute (cfm) of air. In some implementations, the air suction system 1000 can remove between 60 and 100 cfm. Thus, the duct 1010 and aspiration ports 1015 should be appropriately sized.

In order to provide multiple ports having similar cfm characteristics from a single duct 1010, the duct 1010 can include multiple segments (e.g., 1010a, 1010b 1010c, 1010d, and 1010e) of varying dimensions. In general, segments duct 1010 diameter will decrease the further away from the fan 1005 the given segment is. Each segment can have zero, one, or more aspirating ports 1015. Each aspirating port 1015 can include varying dimensions.

The following illustrates example calculations for determining duct 1010 segment properties and aspirating port 1015 properties for an example air suction system 1000 having 5 segments, 5 aspirating ports 115 and assuming the air suction system 1000 is to remove 100 cfm per aspirating port 115.

$$Q = 500 CFM Where Q is the total volume flow ( 100 cfm * \# ports )$$

$$Duct Velocity Pressure ( VP ) = {( \frac{V}{4005} )}^{2}$$

$$V = f ( suction pickup )$$

$$suction pickup = 2.0 ( inches water column ( inWC ) \\ V = 3500 ( feet per minute ( fpm ) ) \\ Duct Area = A = \frac{CFM}{V} \\ Duct Diameter = D = 13.54 \sqrt{A} \\ Ratio = \frac{Duct Length}{Duct Diameter} = \frac{L}{D} = \frac{12 L}{D} \\ Duct Friction Loss = F = 0.0195 * ( \frac{12 L}{D} ) * VP$$

Using the above relations, the following table of duct parameters can be computed for the example implementation.

| | | | Duct | | | | | |
|---|---|---|---|---|---|---|---|---|
| | | Duct | Velocity | | | | | |
| | Q | Velocity | Pressure | Duct | Duct | Duct | Ratio | |
| Section | (FM) | (FPM) | (VP) | Area | Diameter | Length | 12L/D | F |
| 1010ₐ | 500 | 3500 | 0.76 | 0.14 | 5″ | 5′ | 12 | 0.18 |
| 1010_{b} | 400 | 3500 | 0.76 | 0.12 | 4.69″ | 1′ | 2.5 | 0.04 |
| 1010_{c} | 100 | 3500 | 0.76 | 0.09 | 4.0″ | 1′ | 3 | 0.04 |

The fan 1005 should be sufficient strength to provide 60 to 100 cfm suction per port 1015 in the duct 1010. This typically requires the fan to be able to move between 60 cfm and 100 cfm per port 1015.

The implementation illustrated in FIG. 1 shows the system having a single fan 1005 and line of duct 1015, however, it is contemplated that multiple fans 1005 and/or lines of duct 1015 can be used.

Because CO₂ is heavier than many other components of the air, CO₂ will typically fall towards the ground and so ports can be arranged to remove the exhaled CO₂. In addition, air-flow acts as a deterrent and trap, so ports can be located near areas of skin that are more typically exposed, such as the hands and head. The air suction system 100 can be integrated into wearable technology (as described more fully below), existing HVAC systems in buildings, and areas of public gathering, such as stadiums.

In some implementations, exhaust from fan 1005 can be directed to an unpopulated area (e.g., where Aedes aegypti can be harmlessly attracted to). This further protects an area covered by the air suction system 1000 by drawing Aedes aegypti away from the area.

The air suction system 1000 serves as a control (being able to suck Aedes aegypti into the ports), and to reduce Aedes aegypti attractants including CO₂ and other olfactory attractants. By reducing Aedes aegypti attractants, the air suction system 100 serves to cut the trail the Aedes aegypti follow to find a host.

Wearable Insect Devices

The air suction system 1000 can be implemented as a wearable device. For example, the current subject matter includes wearable technology, such as a wrist or neck worn device that protects exposed skin by creating a localized air pressure differential such that air flow traps mosquitos attempting to land on the exposed skin. The suction may be created by a fan and ducts worn on the body, for example, the fan may be carried in a backpack. The duct 1010 can be implemented as flexible tubing, such as surgical tubing with apertures as ports. One or more ducts 1010 can extend from the fan (e.g., in a pack) through the wearers clothing and attach to a necklace having ports to protect exposed skin on the neck and head. Similarly, the one or more ducts 1010 can extend through the wearers clothing and attach to wristbands located at the wrist to protect exposed skin on the hands.

In some implementations, the wearable suction system can be integrated into a jacket or shirt so that the user can put the jacket or shirt on to protect themselves.

The wearable technology may be combined with chemical repellants such DEET (N-diethyl-meta-toluamide) to further protect exposed skin in a localized (e.g., personal) area.

In some implementations, the wearable device can also include a CO₂ removal component to remove CO₂ from the air that is drawn into the device. In particular, by removing or reducing the CO₂ surrounding the wearer, Aedes Aegypti are less likely to become activated and search for a host. The CO₂ removal component can include passing the air that is sucked into the device through a cartridge containing a CO₂ removal compound, which can include, for example, soda lime, calcium hydroxide, and sodium hydroxide.

Soda lime is a mixture of chemicals that is created by treating Calcium hydroxide with concentrated sodium hydroxide solution. The main components of soda lime are calcium hydroxide Ca(OH)₂, water H₂0, sodium hydroxide, NaOH and Potassium hydroxide KOH. Calcium hydroxide is a colorless crystal or white powder and is obtained when calcium oxide is mixed with water. Sodium hydroxide NaOH is also known as lye or caustic soda.

Personal Insect Control

The current subject matter can include personal protective materials that may be placed over the skin. The protective materials can removably attach to the body and include an adhesive on a side facing away from the body. Mosquitos that land or otherwise come into contact with the adhesive can become stuck and eventually perish.

Large Scale Air Suction System

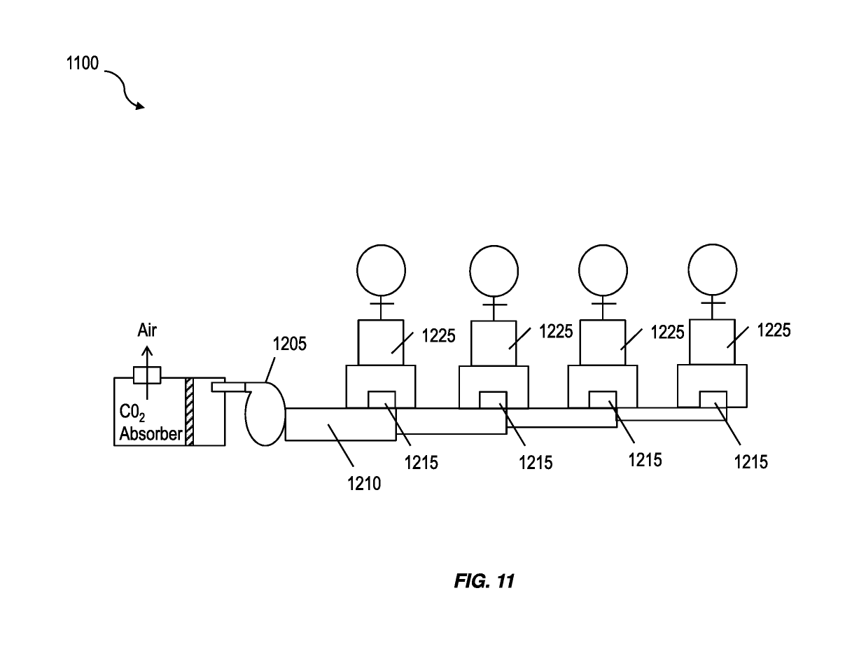

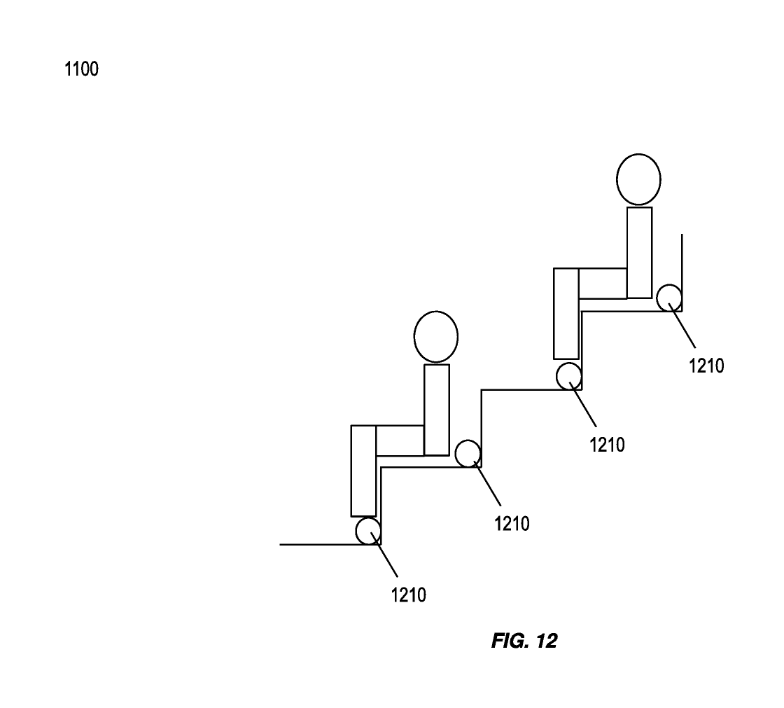

FIG. 11 is a front view and FIG. 12 is a cross-sectional view of an example air suction system 1100 for use with a stadium or other large gathering space. The system provides traps or vents under seating to: 1) trap Aedes aegypti landing on exposed skin by creating a positive suction and air flow; and 2) removes the attractants CO₂ and olfactory attractants like lactic acid from the seating area. The air suction system 1200 includes a fan 1205, duct 1210 with ports 1215 (e.g., vents, apertures, or openings), and a CO₂ 1220 absorber such as soda lime, calcium hydroxide, and sodium hydroxide.

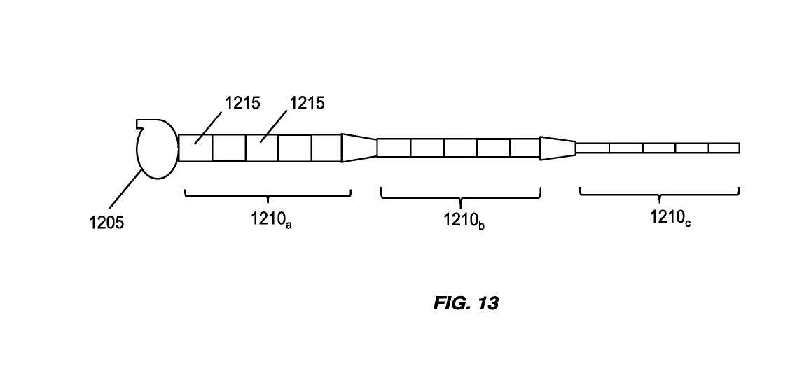

The ports 1215 can be located near where an individual would sit. For example, underneath their seat. For each seat, the air suction system 1200 should be able to remove 60 cubic feet per minute (cfm) of air. In some implementations, the air suction system 1200 can remove between 60 and 100 cfm per port 1215, although multiple ports 1215 can be used per seat that combine to remove between 60 and 100 cfm. Thus, the duct 1210 and ports 1215 should be appropriately sized. FIG. 13 is a cross-sectional diagram of an example duct 1210 illustrating how duct 1210 can be sized to accommodate between 60 cfm and 100 cfm of airflow for a large number of ports. Duct 1210 can be staged such that it has multiple portions (e.g., 1210ₐ, 1210_{b}, and 1210_{c}) or stages with different diameters. The portions of duct 1215 may be connected, for example, by reducers. Closer to the fan 1210 the diameter of each stage is larger allowing for more air flow. Further away from the fan, the diameter of each stage is smaller.

The fan 1205 should be sufficient strength to provide 60 to 100 cfm suction per port 1215 in the associated piping 1210. This typically requires the fan to be able to move between 60 cfm and 100 cfm per port 1215.

The implementation illustrated in FIG. 11 shows the system having a single fan 1205 and line of piping 1215, however, it is contemplated that multiple fans 1205 and/or lines of piping 1215 can be used. In addition, the piping 1215 is shown under the seats in FIGS. 11-13 but can be located elsewhere, for example, the piping 1215 can be integrated into seat handles. Because CO₂ is heavier than many other components of the air, CO₂ will typically fall towards the ground and so ports can be arranged to remove the exhaled CO₂. In addition, air-flow acts as a deterrent and trap, so ports can be located near areas of skin that are more typically exposed, such as the hands and head. The air suction system 200 can be integrated into existing HVAC systems, minimizing costs to install the system. Multiple ports 1215 may be provided per seat (e.g., per person).

In some implementations, the CO₂ 1220 absorber is not included and the exhaust from fan 1205 can be directed to an unpopulated area (e.g., where Aedes aegypti can be harmlessly attracted to). This further protects an area covered by the air suction system 1200 by drawing Aedes aegypti away from the area.

The air suction system 1200 serves as a deterrent (by providing air flow), a control (being able to suck Aedes aegypti into the ports), and to reduce Aedes aegypti attractants including CO₂ and other olfactory attractants. By reducing Aedes aegypti attractants, the air suction system 1200 serves to cut the trail the Aedes aegypti follow to find a host.

In addition, the air suction system 1200 can serve to protect large gatherings of people from terrorist or other attacks. For example, should a chemical and biological attack occur at a stadium, the air suction system 1200 can serve to suck the chemical or biological components out of the area quickly.

The current subject matter is not limited to a stadium but can include a residential building, office building, and other location where it is advantageous to suppress mosquito attracts and to trap and control mosquitos.

High-Contrast Attractant Surfaces and Traps

The current subject matter can include a high-contrast mosquito attractant surface. In some implementations, a large (e.g., 10 feet by 10 feet) panel can placed to protect local regions. Because Aedes aegypti are attracted to high-contrast objects, they will land on the high-contrast panel and not on any nearby humans.

Aedes aegypti host seeking strategy includes visually seeking out a host within 5 to 15 meters. The Aedes aegypti will choose the best visual target within its field of view. For example, if a human is standing next to a cow, the Aedes aegypti will more likely choose to land on the cow than the human because the cow is larger.

The Aedes aegypti are visually attracted to objects with high-contrast low-reflectivity and dark surfaces. Thus, artificial objects can be created and placed so that, when an Aedes aegypti is visually searching for a host, the Aedes aegypti decides to land on the artificial object and not a nearby human. The artificial object can include a panel, for example, a large format printed or painted sheet or panel. The artificial object can have a surface colored with a black and white high-contrast low-reflectivity (e.g., matte) surface. The pattern can be, for example, a “zebra”-like pattern.

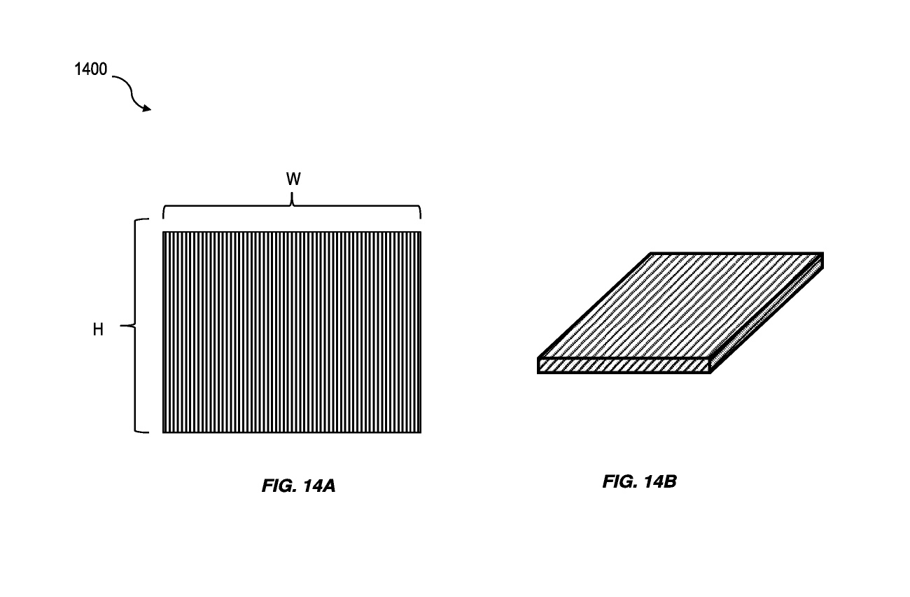

FIG. 14A is a top view and FIG. 14B is a side perspective view of an example high-contrast attractant panel 1400. The high-contrast attractant panel 1400 can include an alternating dark and light stripped pattern. The illustrated pattern is alternating vertical clack and white bars although other patterns (e.g., similar to a zebra) and variations in dark and light color are contemplated. In some implementations, the number of dark bars is greater than the number of light bars. The high-contrast attractant panel 1400 can be produced in large format having a given height and width, for example, 10 feet by 10 feet. In some implementations, the high-contrast attractant panels 1400 should be larger than a person (e.g., 6 feet by 6 feet or greater) to encourage Aedes aegypti to land on the panel, and not a person. In other words, the high-contrast attractant panel 1400 can act to cloak nearby humans so the Aedes aegypti concentrate on the high-contrast attractant panel 1400 and not nearby humans.

Because an Aedes aegypti searches for visual ques within a 5 to 15 meter radius, the high-contrast attractant panel 1400 provides immediate protection to those within 5 to 15 meters of the high-contrast attractant panel 1400. In addition, the high-contrast attractant panel 1400 can be combined with CO₂ and other attractants to protect larger regions. The additional attractants may be active, for example, a UV source. The additional attractants may be passive, for example, people near the high-contrast attractant panel 1400 can serve as a CO₂ source. Multiple high-contrast attractant panels 1400 can be used over a larger region to protect the larger region.

The high-contrast attractant panel 1400 is most effective during the day when Zika carrying Aedes aegypti are most active although can be combined with light sources at night to improve efficacy at night. The high-contrast attractant panel 1400 is attractive for use in under developed countries because it can be implemented inexpensively.

The high-contrast attractant panel 1400 can be combined with control technology, for example, a trap or other device that controls (e.g., kills) the mosquitos that land or approach the high-contrast attractant panel 1400.

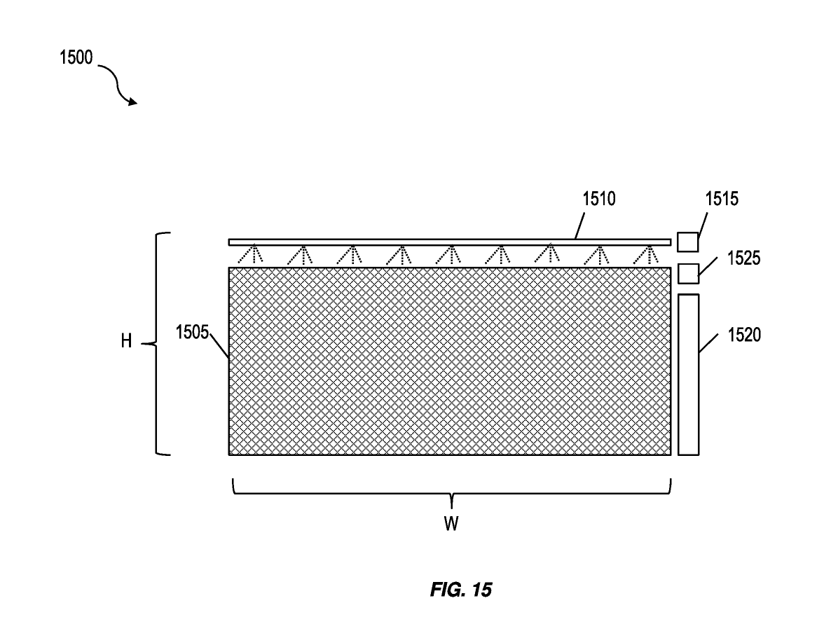

FIG. 15 is a diagram illustrating an insect trap 1500 incorporating a high-contrast attractant surface, which can be combined with other attractants or repellants, for example, in liquid form. The insect trap 1500 can include a screen 1505 having a height and width and formed of a mesh, which can be metallic or non-metallic. The screen 1505 is patterned to be a high-contrast attractant panel. The insect trap 1500 further includes a tube 1510 for spraying or soaking the screen 1505 with one or more of an attractant and a repellant. The tube 1510 is connected to a pump 1515, which pumps fluid (e.g., attractant and/or repellant) from a tank 1520. Controller 1625 causes the pump 1515 to actuate at regular intervals, for example, every 1, 5, 10, 15, 30, 60 and 120 minutes. By intermittently spraying the screen 1505, the insect trap 1500 includes a slow release attractant or repellant.

The spraying of the screen 1505 can act as an immediately local attractant. For example, the spray can include attractants such as water (e.g., moisture), or water containing L-lactic acid, acetone, dichloromethane, dimethyl disulfide, octanol, and compounds to create odors and gases that are emitted from rotting foods and animal wastes. By combining the high-contrast surface with additional attractants, the insect trap 1505 can provide a powerful visual and olfactory attractant trap.

Some implementations can include additional or alternative control means. For example, the screen 1505 may be energized to shock mosquitos that land on the screen 1505, use acoustics that pierce Aedes aegypti bodies, and the like. In some implementations, Aedes aegypti can become trapped in the screen upon landing on the screen.

In some implementations, the spray includes water and/or a pesticide. The high-contrast pattern can serve to attract Aedes aegypti while the pesticide can serve as a control means when the Aedes aegypti land on the screen 1505.

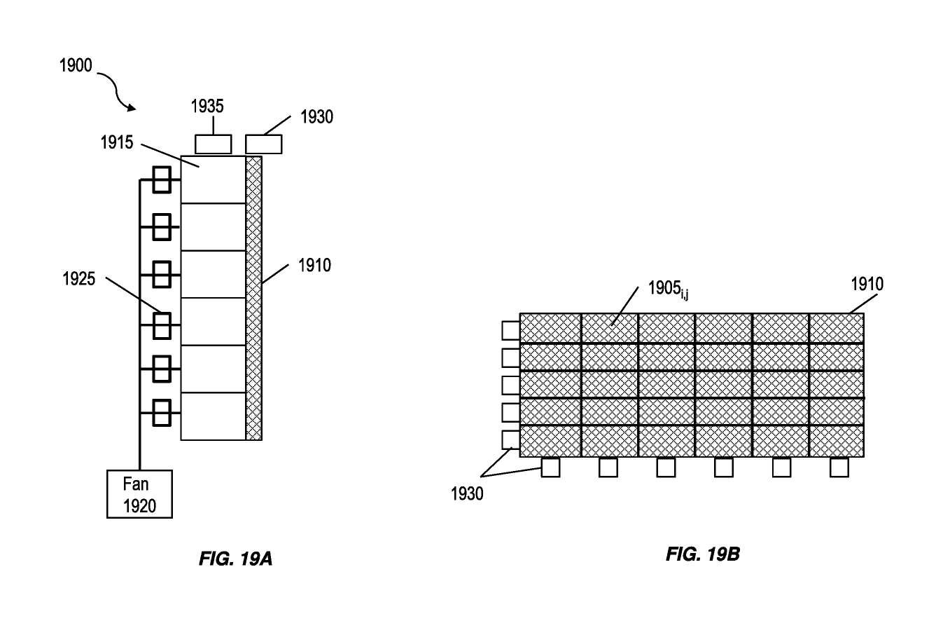

FIG. 19A is a side view and FIG. 19B is a top view of an example high-contrast attractant panel suction trap 1900 having multiple sucking regions 1905_{i,j}. The suction trap 1900 includes a high-contrast panel 1910 formed of a mesh or other material. The panel 1910 is divided into multiple regions 1905_{i,j}, each region having an independently controlled suction means 1915 behind the panel 1910. The suction means 1915 can be a duct opening with each duct connected to a central fan unit 1920. Control valves 1925 can be included for each duct opening. In some implementations, an independent fan unit is included for each region 1905_{i,j}. The suction trap 1900 can include a motion or sound detector 1930 in operative communication with a controller 1935 for detecting motion or sound near the surface of the trap 1900.

In operation, the motion or sound detector 1930 detects when and where motion or sound occurs near the surface of the panel 1910. When motion or sound is detected over a particular region 1905_{i,j}, the controller 1935 controls valves 1925 and fan unit 1920 to create suction at that region for a period sufficient to suck and trap any insects near the surface of the panel 1910. The suction trap 1900 is energy efficient in that it only requires suction on a single region 1905_{i,j}, at any given time.

The current subject matter is not limited to panels and can include other shapes as well. For example, the artificial object can include stickers, billboards, curtains, screens, lamps, and traps having the high-contrast pattern. The insect trap 1600 can be implemented vertically or horizontally. For example, the insect trap 1600 can be implemented as a screen door to a building.

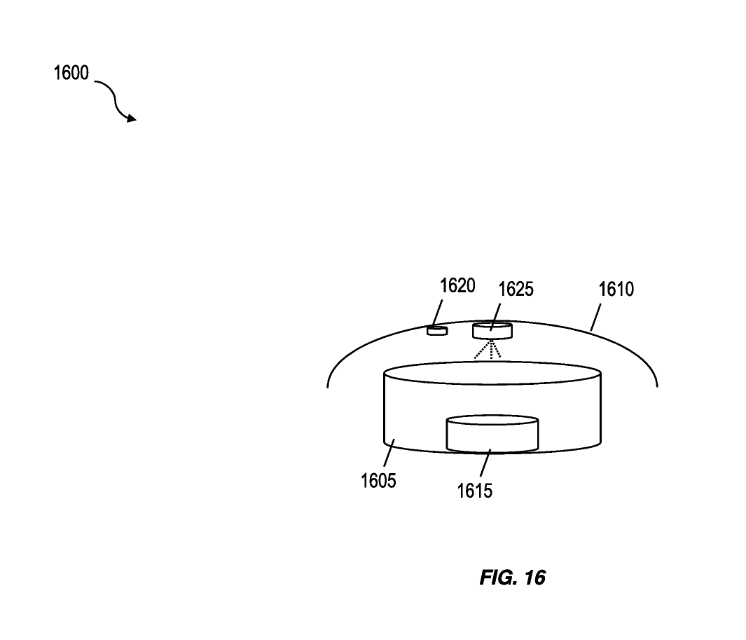

FIG. 16 is an illustration of a fanless trap 1600 utilizing a high-contrast visual attractant surface. The fanless trap 1600 includes a container 1605 and covering 1610, with space between the container 1605 and covering 1610 to allow mosquitos to fly into the container 1605. Both the container 1605 and covering 1610 can have a high-contrast visual attractant surface. Inside the container 1605 can be additional attractants 1615 such as stagnant water, a C0₂ source, other olfactory attractant source (e.g., L-lactic acid, acetone, dichloromethane, dimethyl disulfide, octanol, and the like), a IR source, a UV source, a thermal source, and the like. The fanless trap 1600 can include an auditory attractant that creates noise at approximately 484 Hz, which is the frequency that female Aedes aegypti flap their wings. By providing this auditory attractant, male Aedes aegypti are attracted to the fanless trap 1600. In turn, female Aedes aegypti will be attracted to the male Aedes aegypti in and around the fanless trap 1600.

Fanless trap 1600 can include a control device 1625 for controlling (e.g., killing) mosquitos. The control device 1625 can include a sprayer with associated tank that sprays an insecticide within container 1605 at regular intervals or when mosquitos are detected within the fanless trap 1600. The spray may coat container 1605 and/or covering 1610 with an insecticide that kills Aedes aegypti when they land on a surface of the container 1605 or covering 1610. Insecticides can include, for example, DEET, citronella, malathion, and naled. Other control means are possible, for example, container 1605 and/or covering 1610 can be energized to shock mosquitos that land on them, use acoustics that pierce Aedes aegypti bodies, and the like. In some implementations, the container 1605 and covering 1610 can be formed of a mesh or screen and Aedes aegypti can become trapped in the upon landing on the mesh.

Regional Integration of Control Technologies

The current subject matter can relate to arranging different insect control technologies and devices over a larger geographic region, such as a city block or an entire city or urban region. The insect control technologies and devices can be arranged in a manner that combines attractants with repellants such that in areas containing high human population, mosquito attractants are reduced and repellants are increased while in a nearby region of low human population, attractants are increased and repellants are reduced. By utilizing and layering multiple control approaches, protection can be increased.

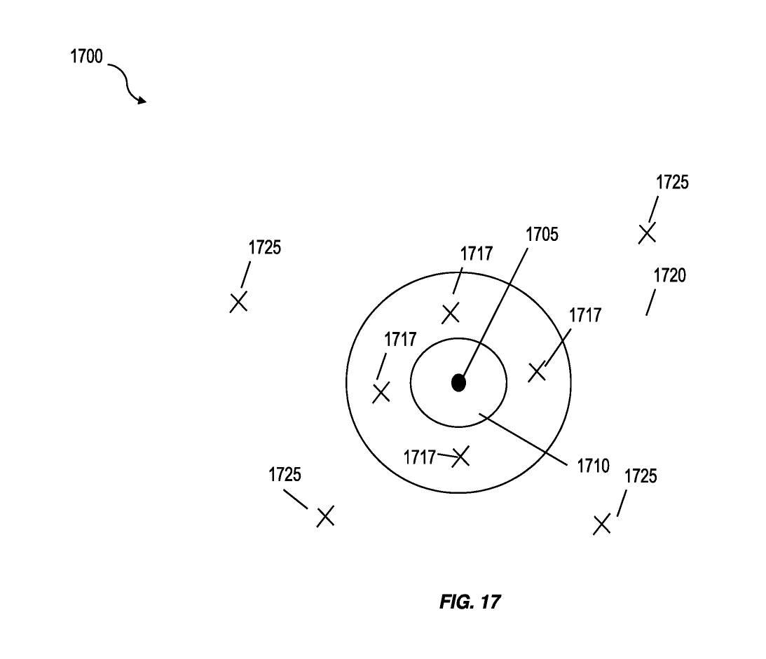

FIG. 17 is a diagram illustrating regions 1700 of influencing Aedes aegypti for protecting an area. For a given point 1705 to protect, for example, the location of a person or place frequented by many people, there are three regions. Specifically, a trap region 1710, a repellant region 1715 and an attractant region 1720. Near the point 1705 to protect, trap region 1710 includes one or more Aedes aegypti traps such that any Aedes aegypti within the region will likely be trapped. This is because it is likely near point 1705 to protect are people who will serve as attractants to any nearby Aedes aegypti who would not be driven away by a repellant or other attractant. The trap region 1710 can include traps such as air suction systems, personal insect control, high-contrast attractant traps, fanless traps, and wearable insect control devices described above. Other traps can be included.

Further away from point 1705 to protect, repellant region 1715 includes repellant sources 1717 so that any mosquitos within the repulsion region are driven out of the repellant region 1715 into either the trap region 1710 (where they are controlled by the traps) or to an attractant region 1720 further away from point to protect 1705. Because Aedes aegypti typically follow attractant trails (e.g., CO2 and other olfactory attractants), the repellant region 1715 also serves to cut any Aedes aegypti from the attractant region 1720 from following an attractant trail into the trap region 1710 and near point 1705 to protect. The one or more repellants can include, for example, DEET, citronella, malathion, and naled.

Attractant region 1720 includes one or more attractant sources 1725 to draw Aedes aegypti away from the point 1705 to protect. These attractants can include, for example, the high-contrast attractant panel described above, CO₂ source, L-lactic acid source, acetone source, dichloromethane source, dimethyl disulfide source, octanol source, IR sources, UV sources, thermal sources, and the like.

The combination of approaches for protecting an area as illustrated in FIG. 17 provides for greater protection because it allows for both traps, repellants, and attractants to be used in combination and according to their strengths. Further, rather than trying to control (e.g., kill) all mosquitos in an area, which can be very difficult to achieve, the scheme described in FIG. 17 allows for Aedes aegypti to be redirected away from populated areas to unpopulated areas.

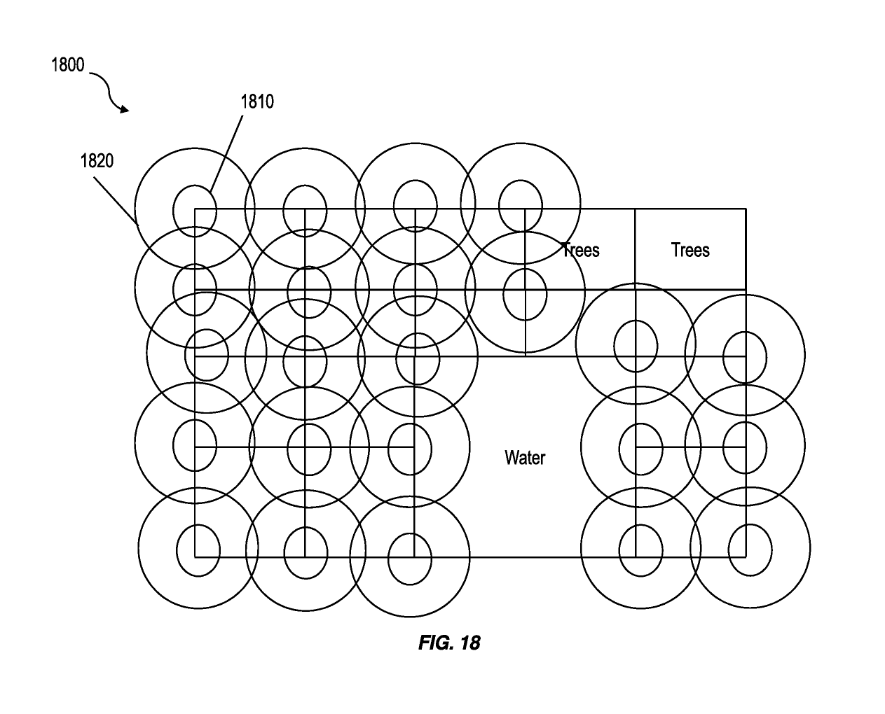

The scheme described in FIG. 17 can be applied to protect a large region, such as an entire city. FIG. 18 is a diagram illustrating how multiple systems can be used to protect a large geographic region. FIG. 18 illustrates a grid 1800 representing city blocks. The vertical and horizontal lines represent streets and their crossing represents intersections. Each block can be considered a city block. Some city blocks contain buildings while other city blocks contain natural features such as bodies of water (e.g., lake or pond), and vegetation (e.g., trees, parks, and the like). Overlain on the grid 1800 are circles representing the regions described in FIG. 17. Each intersection can be the place to protect 1705, which includes a trap region 1710, repellant region 1715, and attractant region 1720, containing respective traps, repellents, and attractants.

Thus, according to the scheme illustrated by FIG. 18, Aedes aegypti are trapped and controlled (e.g., killed) near intersections of a city, are repelled away from streets and blocks that contain buildings, and attracted to regions in between the populated streets. The regions the Aedes aegypti are guided to can include natural features such as bodies of water (e.g., lake or pond), and vegetation (e.g., trees, parks, and the like).

In an example implementation, Aedes aegypti traps such as air suction systems, high-contrast attractant trap, and fanless trap are placed at city intersections. The traps can be integrated with city lights, which already serve as localized attractants (e.g., UV and IR sources) or with artificial trees that can include CO2 sources. Repellant sources such as DEET, citronella, malathion, and naled can be placed along streets. Attractants such as the high-contrast attractant panel described above, CO₂ source, L-lactic acid source, acetone source, dichloromethane source, dimethyl disulfide source, octanol source, IR sources, UV sources, thermal sources, and the like, can be placed between streets and preferably in under populated areas such as areas that contain vegetation. The attractant sources can be disguised, for example, as artificial trees that include CO2 sources, or street lights.

The current subject matter can scale to be used to protect regions of varying size. For example, the current subject matter can protect a single city block (e.g., a region having a radius of approximately 50 meters), or an entire city (e.g., a region having a radius of 1 kilometers, 5 kilometers, 10 kilometers, or more). Moreover, the current subject matter need not be limited to protecting cities laid out on a perfect grid, other configurations and arrangements are possible.

Other Implementations

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. An apparatus comprising:
a fan;
an attractant source;
a repellent source; and
a controller operatively coupled to the fan, the attractant source, and the repellent source, the controller configured to perform operations comprising:
receiving data characterizing a proximity of a person or an insect; and
changing a mode of operation of the apparatus based on the received data, wherein changing the mode of operation includes modifying operation of one or more of the fan, the attractant source, and the repellent source.

2. The apparatus of claim 1, further comprising:
a remote interface configured to communicate wirelessly; and
a data acquisition unit.

3. The apparatus of claim 2, wherein the data characterizing the proximity of the person or the insect includes an instruction received wirelessly from a mobile device or a remote network gateway, the data received by the remote interface.

4. The apparatus of claim 3, wherein the received data characterizes the proximity of the person and the changing the mode of operation includes increasing an output of the repellant source or increasing an output of the attractant source.

5. The apparatus of claim 3, wherein the received data characterizes the proximity of the insect and the changing of the mode of operation includes increasing an output of the attractant source and operating the fan.

6. The apparatus of claim 2, wherein the data characterizing the proximity of the person of the insect is received from the data acquisition unit, the received data including one or more sensor measurements, the controller configured to perform further operations comprising:
determining, from the received data, one or more data features; and
detecting, based on the features, a proximity of a person or an insect.

7. The apparatus of claim 6, wherein the controller is configured to perform further operations comprising:
classifying, based on the features, a type of insect, wherein changing the mode of operation is based on the type of insect.

8. The apparatus of claim 2, wherein the controller is configured to perform further operations comprising:
communication, using the remote interface, with a second insect trap including a second fan, a second attractant source, a second repellent source; and a second controller; and
establishing a communication session with the second insect trap;
wherein the received data characterizes the proximity of the person or insect to the second insect trap, the changing of the mode of operation includes increasing an output of the attractant source and operating the fan in response to the received data characterizing proximity of the person to the second trap, the changing of the mode of operation includes increasing an output of the repellent source in response to the received data characterizing proximity of the insect to the second trap.

9. The apparatus of claim 1, wherein the attractant source includes one or more of: ultraviolet light source, thermal source, infra-red source, acoustic source, carbon dioxide (CO₂) source, L-lactic acid source, acetone source, dichloromethane source, dimethyl disulfide source, and octanol source.

10. The apparatus of claim 1, wherein the repellent source includes one or more of: N-diethyl-meta-toluamide (DEET), citronella, malathion, and naled.

11. The apparatus of claim 2, wherein the data acquisition unit includes one or more of: passive IR sensor, video camera, motion sensor, temperature sensor, moisture sensor, carbon dioxide sensor, geolocation positioning system (GPS), wind sensor, anemometer, and photocell.

12. The apparatus of claim 1, wherein the controller includes a predictive model for operating the fan, the attractant source, and the repellent source; the controller configured to perform operations further comprising:
receiving a supervisory signal indicating an effectiveness of the predictive model; and
updating the predictive model in response to the supervisory signal.

13. The apparatus of claim 2, the controller configured to perform further operations comprising:
recording an output of the data acquisition unit; and
transmitting, using the remote interface, the recorded output of the data acquisition unit to the mobile device or the remote network gateway.

14. A method comprising:
receiving, by a controller, data characterizing a proximity of a person or an insect, wherein the controller is operatively coupled to a fan, an attractant source, and a repellent source; and
changing, based on the received data, a mode of operation of one or more of the fan, the attractant source, and the repellent source.

15. The method of claim 14, wherein the controller is further operatively coupled to: a remote interface configured to communicate wirelessly; and a data acquisition unit.

16. The method of claim 15, wherein the data characterizing the proximity of the person or the insect includes an instruction received wirelessly from a mobile device or a remote network gateway, the data received by the remote interface.

17. The method of claim 16, wherein the received data characterizes the proximity of the person and the changing the mode of operation includes increasing an output of the repellant source or increasing an output of the attractant source.

18. The method of claim 16, wherein the received data characterizes the proximity of the insect and the changing of the mode of operation includes increasing an output of the attractant source and operating the fan.

19. The method of claim 14, wherein the data characterizing the proximity of the person of the insect is received from the data acquisition unit, the received data including one or more sensor measurements, the method further comprising:
determining, from the received data, one or more data features; and
detecting, based on the features, a proximity of a person or an insect.

20. The method of claim 19 further comprising:
classifying, based on the features, a type of insect, wherein changing the mode of operation is based on the type of insect.

21. The method of claim 14, wherein the insect comprises a pathogen.

22. The method of claim 21, wherein the pathogen includes Chikungunya virus; Dengue fever virus (DENV); RVF virus; Yellow fever virus; Zika virus; Plasmodium falciparum; Plasmodium vivax; Plasmodium ovale; Plasmodium malariae; Japanese encephalitis virus; Wuchereria bancrofti; Brugia malayi; Brugia timori; and/or West Nile virus (WNV).
